(19) United States
(12) Patent Application Publication
(10) Pub. No.: US 2007/0050354 A1
(43) Pub. Date: Mar. 1, 2007

(54) METHOD AND SYSTEM FOR MATCHING SOCIALLY AND EPIDEMIOLOGICALLY COMPATIBLE MATES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/465,774

(22) Filed: Aug. 18, 2006

Related U.S. Application Data
(60) Provisional application No. 60/709,506, filed on Aug. 18, 2005.

(51) Int. Cl. G06F 17/30

(52) U.S. Cl. 707/5

(57) ABSTRACT

A system, method, and service for computer moderated matchmaking in which at least one final candidate is selected from a plurality of potential candidates based upon both social compatibility and epidemiological compatibility determinations made with respect to a user. In some embodiments communication is selectively facilitated between the user and the at least one final candidate. In some embodiments the user may set threshold values and/or other customizable preference values with respect to the epidemiological compatibility determination.

### RELATED APPLICATION DATA

This application claims priority to provisional application Ser. No. 60/709,506, filed Aug. 18, 2005, the disclosure of which is hereby incorporated by reference as if fully set forth.

### FIELD OF THE APPLICATION

The present invention relates generally to operation of an on-line computer dating service, and more specifically to a system, method, and apparatus for identifying potential mates for a plurality of users and providing communication between users who are likely to have a successful relationship.

### BACKGROUND

The completion of the sequencing of the human genome has been hailed as a pivotal milestone in the history of biology and medicine, for it has allowed researchers to identify specific genes and/or combinations of genes that are associated with increased risk for certain diseases and disorders. In fact, scientists are continually surprised by the rapid and numerous identified linkages between genes and diseases, including linkages between a wide variety of diseases not normally considered “genetic.” Furthermore, scientists are collecting more and more knowledge about the interplay between genetic propensity for diseases and environmental factors that also effect disease such as smoking, sun exposure, and diet. This has lead to the birth of a new field of research called Human Genome Epidemiology or HuGE that focuses on using human genetic information to improve health and prevent disease.

Human Genome Epidemiology has the potential to protect and/or cure individuals from disease by analyzing their unique individual genetic code (i.e., genotype) and providing specific prevention plans and/or treatment plans that are tailored to their genes. While such genetically guided interventions have great potential to prevent and/or cure disease in individuals, this approach does nothing to improve the genetic makeup of future generations of people. In fact, this approach could inadvertently worsen the genetic makeup of future generations by allowing individuals with a high propensity for certain disorders to flourish in greater numbers and pass their genes more freely to offspring. Such a consequence is certainly justifiable considering the great value to the health of individuals. That said, it would be further beneficial to future generations to have additional processes that work to reduce or even reverse this effect. More specifically, it would be beneficial to develop methods and apparatus that employ the technologies and techniques of individual genetic testing and Human Genome Epidemiology not only to protect and/or cure current individuals from disease, but to increase the likelihood that the offspring of current individuals have a genetic makeup that reduces their propensity for certain diseases.

On-line computer dating services, also called computer dating services or a computer matching services or simply matching services, are computer moderated systems that helps users find compatible individuals for a dating relationship. In most cases the long-term objective of such a dating relationship is the formation of a family unit through marriage and procreation. In fact, one popular matching service called eHarmony.com boasts that thousands of successful marriages have resulted from their computer moderated matching environment in the first few years of operation. Furthermore, recent research presented at the American Psychological Society found that couples who married as a result of the eHarmony service are significantly happier than couples married for a similar length of time who met by more traditional means. Thus it is an objective of many individuals who use matching services is to find a compatible mate with whom to get married and have children. Unfortunately the methods and technologies employed by eHarmony and other matching services focus only on relationship-related compatibility factors, ensuring that matched individuals are socially compatible with each other, but not ensuring that matched individuals are genetically compatible with respect to the propensity to disease that their resulting offspring would have if they had children together.

U.S. Pat. No. 6,735,568, which is hereby incorporated by reference, discloses a matching service that is a computer moderated system that attempts to identify and bring together two or more people that the matching service believes may have a successful relationship. Many matching services identify matches by techniques that find people with common personalities, interests and/or beliefs. However, these matching techniques often do not account for the large number of variables that can determine whether a relationship is successful. Research has shown that the success of human relationships depends on complex interactions between a large number of additional factors including, but not limited to, personality, socioeconomic status, religion, appearance, ethnic background, energy level, education, interests and relationship preferences and tendencies. These factors that can be used predict the likely success of a social relationship are referred to herein as social factors. The large number of variables involved in determining relationship success based upon documented social factors has made predicting the success of a relationship to be difficult. To address this problem, current systems, such as the one disclosed in U.S. Pat. No. 6,735,568, perform detailed analysis upon a large number social factors of its users to predict the satisfaction that a user will have in a relationship with a particular other user. Generally the process works for a particular user by comparing a variety of social factors related to that user's background, appearance, relationships preferences, and relationship tendencies with the social factors determined for a large number of other users so as to identify a relatively small set of candidates with whom the user is most likely to have a successful relationship. To accommodate this process, the methods generally include receiving a plurality of surveys completed by different users. Each survey includes a plurality of inquiries into matters that are relevant to formation of relationships with other people. At least a portion of the inquiries have answers that are associated with a number. The methods also include using the answers which individuals provide to inquiries in a factor analysis so as to identify a plurality of social factors for each particular user and thereby generate an individual satisfaction estimator. Some embodiments include identifying the social factors, as determined by the survey answers that most highly predict a particular user's satisfaction in a relationship. Furthermore, some embodiments employ a neural network to process the social factor information provided by a user and to produce a list of one or more candidates that the neural network has determined will be successful in a relationship with the individual.

Yet despite these advanced features, the currently available on-line computer dating services lack any ability to consider the genomic data of individuals to provide match recommendations for users with whom they likely would produce children that possess a reduced propensity for certain diseases. These and other benefits are enabled by the current invention as disclosed herein.

### SUMMARY

With increases in the speed and efficiency of gene sequencing, technology is getting closer to the day that ordinary people can have their genome analyzed at reasonable cost to determine hidden genetic traits such as their propensity to certain diseases and disorders. For example 454 Life Sciences Corp in Branford, Conn. has recently developed an enhanced system for determining genetic codes from an individual's DNA that is up to 100 times faster than previous techniques. Such advances are finally making practical personalized genetic sequencing for individually tailored medical purposes. While much attention has been paid to using an individuals genetic data for processes such as pharmacogenomics (the tailoring of medical treatments to a person's unique genetic makeup), little attention has been paid to using such data to help reduce the propensity to certain diseases in future generations of people. Embodiments of the present invention address this need by using the gene sequencing data of individuals as matching factors within on-line computing dating systems such that men and women who use the novel system can more easily find mates with whom they're likely to produce children that possess a reduced propensity for certain diseases. More specifically, embodiments of the present invention comprise methods and apparatuses for matching men and women within on-line computing dating systems using both social factors and genome-related epidemiological factors to identify compatible man-woman matches that are likely to be both socially compatible AND likely to produce children that have a reduced propensity for certain diseases.

Embodiments of the present invention provide a unique application of genetic testing, Humane Genome Epidemiology, and on-line computer dating. This combination is directed at preventing disease not in current individuals but in their offspring. More specifically, embodiments of the present invention provide an on-line computing dating service that matches men and women who are compatible not just based upon social factors such as personality, interests, background, and relationship tendencies (as is used by current on-line computer dating services), but also in how their genes are likely to contribute to the propensity for certain diseases to their offspring. The underlying scientific principles that enable the current invention is the fact that certain diseases in a particular individual are genetically caused and/or genetically influenced as a result of that individual having received a certain combination of genes from his/her mother and his/her father. More specifically, a propensity for certain diseases in a specific individual is the result of either (a) that individual possessing a pair of a particular recessive gene as a result of receiving that gene from both his/her mother and his/her father or (b) that individual possessing a certain combination of multiple genes as a result of receiving certain genes from his/her mother and certain genes from his/her father. The present invention is therefore aimed at reducing the propensity for disease in future generations of individuals by reviewing genetic data for individual men and individual women who are seeking mates through an on-line computer dating system and matching the men and the women such that their children would have a reduced likelihood of possessing either (a) one or more pairs of recessive genes that are known to result in a propensity for certain diseases, and/or (b) one or more specific combinations of genes that are known to result in a propensity for certain diseases. In this way the offspring of individuals who are matched using this inventive service may be born with reduced chances of being susceptible to certain diseases.

Thus, the on-line computer dating system disclosed herein uses genetic information of individuals (i.e., their genotype), correlated with Human Genome Epidemiological information (i.e., known statistical relations between particular genes and/or gene combinations with propensity for certain diseases), to recommend man-woman dating matches that are statistically more likely to result in offspring whose genotype has reduced propensity for a certain set of diseases. As used herein, the genetic information of individuals (i.e., their genotype) correlated with Human Genome Epidemiological information (i.e., known relations between particular genes and/or gene combinations with propensity for certain diseases), is referred to collectively as Geno-Epidemiological Factors. Thus, embodiments of the present invention provide an on-line computer dating service that uses Geno-Epidemiological Factors as well as Social Factors (such as personality, religion, socioeconomic status, appearance, ethnic background, energy level, education, interests, relationship preferences, and relationship tendencies) to match men and women with potential mates who are both socially and epidemiologically compatible. By “socially compatible” it is meant that they are statistically more likely than average to have a happy and lasting personal relationship. By “epidemiologically compatible” it is meant that they are statistically more likely than average to produce children together who possess a reduced propensity for certain diseases.

It is important to note that such a system would not be discriminatory against people who possess certain genes and/or combinations of genes but rather would guide people who possess certain genes and/or combinations of genes to mates who possess compatible genes that are less likely to result in certain propensities for disease in any offspring they have together. For example, if a particular man possesses a rare recessive gene that causes propensity to acquire a certain deadly disease, that gene being present in 1 in 1000 individuals, the current invention is configured to consider this fact along with social factors when matching this man with a set of women who are socially compatible with him. In this way, embodiments of the present invention will match this man with women who are not only compatible based upon social factors such as personality, socioeconomic status, religion, appearance, ethnic background, energy level, education, interests and relationship preferences and tendencies, but also who do not possesses this rare recessive gene and/or other genes that might lead to a propensity for certain diseases in offspring produced with him. Thus if the man's match with this woman leads to marriage and children, the children will not have a propensity for the deadly diseases associated with the rare recessive gene or other identified diseases. Furthermore, embodiments of the present invention are directed toward considering a large number of genes and/or combinations of genes known to increase propensity for certain diseases, matching men and women who are best-fits based upon all the information available, both socially based and genetically based. The types of diseases considered by the system may include but are not limited to Breast Cancer, Prostate Cancer, Alzheimer Disease, Coronary Artery Disease, Obesity, Colon Cancer, Lung Cancer, Diabetes, Skin Cancer, Schizophrenia, Alcoholism, Atherosclerosis, and Osteoarthritis, for such diseases have been shown to have genetic links. For example, researchers at UCLA and USC have linked a variation of a gene called 5-lipoxygenase (5-LO) to an increased risk for atherosclerosis, a disease that causes thickening of the arteries. This linkage is the type of information referred to herein as Human Genome Epidemiological information that is considered by the software routines of the present invention to when matching men and women.

Because there are a large number of diseases that are genetically linked to particular genes and/or combinations of genes, embodiments of the present invention provide novel user interface methods that allow users to select which diseases (or types of diseases) they want to most significantly reduce their offspring's propensity for when being matched with candidate mates. For example, some users may chose to only identify life threatening diseases such as cancers that are not easily cured. Other users may choose to also identify chronic diseases that are manageable but cause substantial life difficulties such as diabetes and obesity. Other users may also choose to select lesser diseases such as acne or colorblindness that are not threats to life but still may preferably be avoided by some users. In this way, users can identify which diseases, types of diseases, and/or combinations of diseases that they most want to reduce propensity for in selecting a mate. Furthermore users can identify through the novel user interface of the present invention, the relative importance of certain diseases and/or types of diseases as they are used in the matching process. Finally, the user interface also allows users to identify the relative importance of geno-epidemiological factors and social factors such that the matching algorithms are user configurable in the weighting of social factors versus geno-epidemiological factors when determining candidate mates for the user.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a system for matching people according to at least one embodiment of the invention;

FIG. 2 illustrates a method for performing two analyses to identify particular candidates for a relationship according to at least one embodiment of the invention;

FIG. 3 illustrates the epidemiological analysis according to at least one embodiment of the invention; and

FIG. 4 illustrates a matching service according to at least on embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The present invention relates to the functions and operation of a matching service that employs a database of genetically-linked epidemiological factors in combination with decoded genotype data for a plurality of individual users to help the users find mates with whom they would likely produce children that have a lower propensity for certain diseases as compared to children produced with a randomly selected mate. More specifically, embodiments of the present invention relate to the functions and operation of a matching service that matches men and women who are compatible not just based upon social factors such as personality, interests, background, relationship tendencies, and relationship preferences (as is used by current on-line computer dating services), but also based on how their genes are likely to contribute to the propensity for certain diseases to their offspring. Even more specifically, the on-line computer dating system disclosed herein is a system that accesses and uses the genetic information from a plurality of individuals (i.e., individual genotype data) and correlates this data with a database of Human Genome Epidemiological information (i.e., a database that indicates the linkages between particular genes and/or particular gene combinations with propensity for certain diseases), to recommend man-woman dating matches that are statistically more likely to result in offspring whose genotype has reduced propensity for a certain set of diseases. As used herein, the genotype information for a plurality of individuals as correlated with the database of Human Genome Epidemiological information is referred to collectively as Geno-Epidemiological Factors. Thus, embodiments of the present invention are directed to an on-line computer dating service that uses Geno-Epidemiological Factors as well as Social Factors (i.e., personality, religion, socioeconomic status, appearance, ethnic background, energy level, education, interests, relationship preferences, and relationship tendencies) to match men and women with potential mates who are both socially and epidemiologically compatible. By “socially compatible” it is meant that they are statistically more likely than average to have a happy and lasting personal relationship. By “epidemiologically compatible” it means that they are statistically more likely than average to produce children together who possess a reduced propensity for certain diseases.

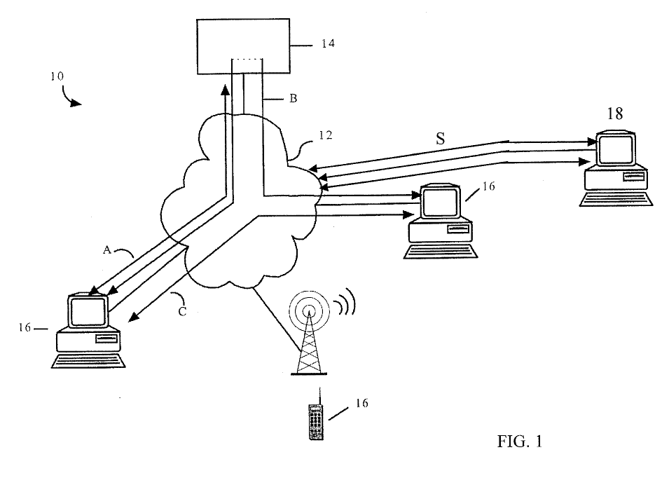

FIG. 1 illustrates a system 10 for matching people according to at least one embodiment of the invention. The system 10 is utilized for matching people who are interested in finding a mate who is compatible not just based upon social factors such as personality, interests, background, relationship tendencies, and relationship preferences (as is used by current on-line computer dating services), but also based on how their genes are likely to contribute to the propensity for certain diseases to their offspring. The system 10 includes a network 12 providing communication between a matching service 14 and one or more remote units 16. The network 12 may also provide communication between the matching service 14 and one or more secure servers 18. The one or more secure servers store genetic information about individual users of the system, the genetic information being preferably captured through genetic testing of the individual users (ideally by a medical genetic testing service). In some embodiments the remote unit 16 and the secure server 18 are the same device. In some embodiments the remote unit 16 is a personal computer local to the user's home or workplace and the secure server is a medical computer system located at a separate medical service provider's location.

The matching service 14 includes one or more processing units for communicating with the remote units 16 and/or with the one or more secure servers 18. The processing units include electronics for performing the methods and functions described in this application. Suitable remote units 16 include, but are not limited to, desktop personal computer, workstation, telephone, cellular telephone, personal digital assistant (PDA), laptop, or any other device capable of interfacing with a communications network. Suitable networks 12 for communication between the server and the remote units 16 include, but are not limited to, the Internet, an intranet, an extranet, a virtual private network (VPN) and non-TCP/IP based networks 12. Suitable secure servers 18 include, but are not limited to, computer workstations, mainframe computers, personal computers, or any other secure device capable of interfacing with a communication network.

A user of a remote unit 16 and the matching service 14 can communicate as shown by the arrow labeled A. Examples of communications include exchange of electronic mail, web pages and answers to inquiries on web pages. The user of the remote unit 16 can also communicate with the user of another remote unit 16 as indicated by the arrow labeled B. The matching service provides the communication by receiving the communication from one user and providing the communication to another user. The matching service 14 can modify the communication from one user to another user. For instance, the matching service 14 can change the user's real name on an e-mail to a username so the sending user's identity is protected. The username can be assigned by the matching service 14 when the user signs up for the service or can be selected by the user when the user signs up for the matching service 14. One user can also communicate directly with another user as shown by the arrow labeled C. This direct communication can occur after the users exchange e-mail addresses or phone numbers during a communication through the matching service 14. Alternatively, one user can request that the matching service 14 provide another user with his/her direct communication information, i.e., e-mail address. The matching service 14 can also access genetic information about the users by communicating over a secure communication link with the secure server 18 as shown by the arrows labeled S. Note, in many embodiments multiple secure server 18 units are employed and accessed separately by the matching service 14 for each of the users. For example, the matching service 14 may access a first set of genetic information for a first user by accessing a first secure server associated with a medical service through which the first user had genetic testing performed AND the matching service 14 may access a second set of genetic information for a second user by accessing a second secure server associated with a medical service through which the second user had genetic testing performed. To facilitate this process, each user of the matching service 14 may supply to the secure server location and/or address at which his or her genetic information is securely located. Again, in some embodiments the secure server 18 and the remote unit 16 may be one and the same. The methods described in the present invention can be performed using only the communications illustrated by the arrows labeled A, B, C, and S. However, other forms of communication can be used including normal mail services, phone calls and directly visiting the matching service.

In addition to the communication paths described above, the matching service 14 of the present invention has access to a database of Human Genome Epidemiology Information. This database is a store of information that indicates known linkages between particular genes and/or particular gene combinations with propensity for certain diseases. In some embodiments, the database is stored locally to the matching service 14. In some embodiments the database is accessed externally over the network 12. For example, one embodiment accesses a database maintained by the Center for Disease Control (or other similar government agency) that keeps the up-to-date linkages between particular genes and/or particular gene combinations with propensity for certain diseases.

The matching service 14 employs a data preparation stage, a matching stage and a communications stage. During the data preparation stage, social data and epidemiological data are collected and/or accessed in preparation for the matching stage. The data is used to match one or more candidates with a user in the matching stage. At the communication stage, communication is achieved between the user and one or more of the users. The communication can occur in one or more communication stages which are selected by the user and the candidate.

Thus the matching service 14 functions to identify and select one or more candidates for a relationship with a user of the service. When the user and one of the selected candidates wish to communicate, the matching service allows them to communicate at a plurality of communication levels. Each of the communication levels allows the parties to exchange information in a different format. Examples of exchanging information at different communication levels include exchanging answers to open-ended questions provided by the matching service, exchanging items selected from a list provided by the matching service, exchanging answers to open-ended questions provided by the matching service and exchanging questions and answers written by the user and/or the candidate. The matching service may be configured to facilitate each exchange of information by receiving a portion of the communication from one party and then forwarding the communication to the other party. The matching service can modify the communication so the identity of the sending party is concealed. As a result, the communication between the parties remains anonymous if desired by sending user.

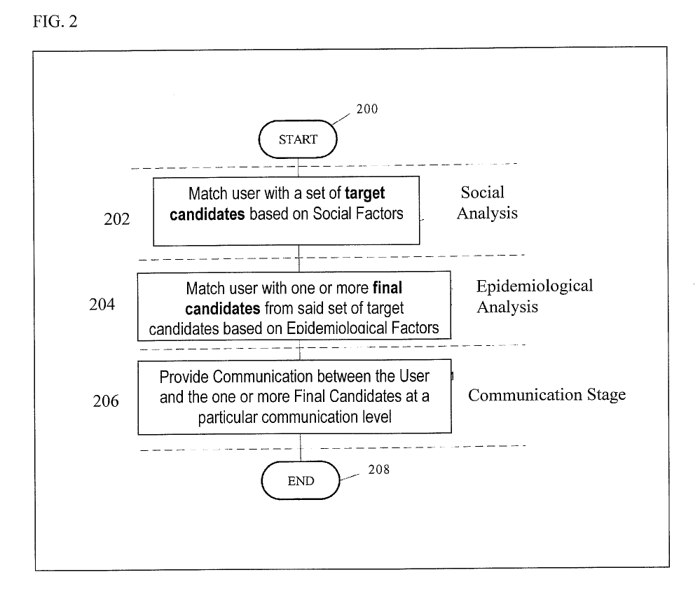

As described herein, some preferred embodiments of the present invention include software routines that perform two forms of analysis to match users with potential mates. One form of analysis is a social analysis that considers social factors to match users with potential mates with whom they are statistically more likely than average to have a happy and lasting personal relationship. The other form of analysis is an epidemiological analysis that considers geno-epidemiological factors to match users with potential mates with whom they statistically more likely than average to produce children who possess a reduced propensity for certain diseases. FIG. 2 illustrates a method for performing two analyses to identify particular candidates for a relationship according to at least one embodiment of the invention. As shown in FIG. 2, some preferred embodiments of the present invention perform these two forms of analysis in sequence, first performing a social analysis at operation 202 and then performing an epidemiological analysis at operation 204, so as to identify particular candidates for a relationship with a given user. Once a final set of candidates are identified (i.e., Final Candidates), the user is given the opportunity through the matching service to communicate with the final candidates during a communication stage at operation 206.

Referring first to the social analysis operation 202, social factors are collected for the user as well as for a plurality of potential candidate mates. This is sometimes referred to as a data preparation or data collection portion of the social analysis stage. In some common embodiments, the social factors are collected through an on-line survey that each user of the system completes. Preferably the surveys include a plurality of inquiries into matters which are relevant to each individual in forming relationships with other people. The social factors are then analyzed with respect to stored statistical information about the satisfaction that people typically have in their relationships. Based upon this analysis a set of target candidates are identified for the user from the plurality of potential candidate mates, the set of target candidates being those candidates with whom the user is most likely to have a positive relationship. A number of specific methods may be followed by which to perform the social analysis and thereby identify the set of target candidates for the user. For example, the methods disclosed in U.S. Pat. No. 6,735,568 (which is incorporated by reference herein) may be used.

Once a set of target candidates are identified for the user, the target candidates being those other users of the system with whom the user is likely to have a positive social relationship, at operation 204 the epidemiological analysis is performed to determine which candidates of the set of target candidates are epidemiologically compatible with the user. During the epidemiological analysis operation 204, individual genotype data that has been collected for the user as well as for the plurality of potential mates in the set of target candidates are analyzed with respect to a stored database of information that indicates known linkages between particular genes and/or particular gene combinations with propensity for certain diseases (i.e., the database of Human Genome Epidemiology Information).

The genotype data for the user may be collected through genetic testing procedures that decode some or all of the genetic information present within the user's individual genome and represents the data in a digital format. Similarly, genotype data for each of the target candidates is likely collected through genetic testing procedures that decode some or all of the genetic information present within that candidates individual genome and represents the data in a digital format. A variety of methods exist for decoding the genetic information of individuals, such methods becoming increasingly faster and less expensive. For example, 454 Life Sciences Corp in Branford, Conn. has recently developed an enhanced system for determining genetic codes from an individual's DNA that is up to 100 times faster than previous techniques. Such genetic testing is generally performed at a genetic testing facility and/or medical facility and the digital format genetic information for the user and/or for each of the candidates is generally stored upon one or more secure servers or other secure digital storage mediums. To support the epidemiological analysis described herein, the genome data (or a portion thereof) of the user and the genome data (or a portion thereof) of each of the target candidates is generally accessed over a secure link by the software routines of the matching service of the present invention.

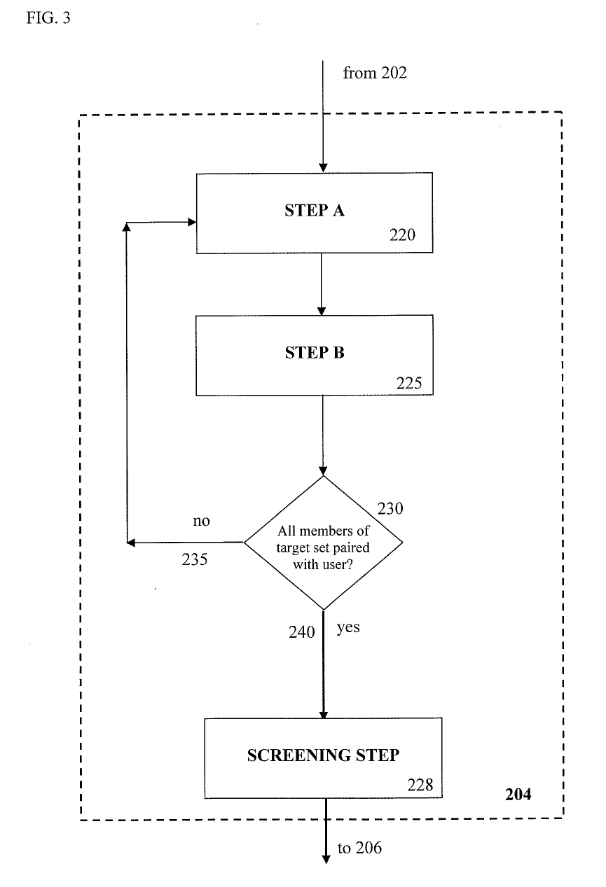

FIG. 3 illustrates the epidemiological analysis according to at least one embodiment of the invention. The epidemiological analysis operation 204 is performed in a series of two steps which are conditionally repeated until all of the target candidates are analyzed with respect to the user. A first step 220 is referred to herein as Step A. A second step 225 is referred to herein as Step B. After Step B 225 is performed, a conditional relation step 230 is performed, conditionally repeating Step A 220 and Step B 225 by following branch 235 for so long as all of the target candidates have not yet been analyzed with respect to the user. Once all of the target candidates have been analyzed with respect to the user, the alternate branch 240 is followed and the epidemiological analysis operation 204 performs a Screening Step 228 and then passes a set of Final Candidates to the communication operation 206. More specifically, the epidemiological analysis operation 204 of this embodiment is implemented as described below.

In Step A 220 of the epidemiological analysis, software routines access the individual genotype data for the user as well as individual genotype data for a first member of the set of target candidates. Using these two sets of individual genotype data, the software routines compute the possible gene combinations (and a statistical likelihood of those combinations) that may result in an offspring having the user and the first member as its two parents. It should be noted that the possible gene combinations need only be computed with respect to the specific genes that are known to possibly affect the propensity for the certain diseases being screened for. Thus if 38 specific genes in a individuals genotype, when combined in certain specific ways, are known to affect the propensity for a certain set of diseases being screened for, only those 38 specific genes need be considered when the software routine computes the possible gene combinations (and their statistical likelihood) that can result from the genetic pairing of the user's genotype and the first members genotype. For the purposes of clarity, the set of possible gene combinations that can result from the genetic pairing (i.e., the mating) of the user and a particular target member (in this case the first member) along with the statistical likelihood that each of the combinations will result is referred to herein as the Combinational Genotype for that user and that target member. In practical terms, the Combinational Genotype represents the set of possible genotypes that a child could have (with respect to a certain set of genes) if that child were born to the user and the particular target member and the statistical likelihood that each of the set of possible genotypes will result. In some embodiments a single Combinational Genotype is computed during Step A that represents the possible combinations of all the genes that can effect the certain set of diseases being screened for. In other embodiments multiple Combinational Genotypes are computed, each of the multiple Combinational Genotypes considering a different set of genes that are specifically related to a different disease or different set of diseases. Thus depending upon the implementation, the output of Step A is a single Combinational Genotype or a set of Combinational Genotypes for the user and the first member. Regardless of how it is represented, the data output of Step A is information representing the statistical likelihood that certain specific combinations of certain specific genes will result from the pairing of the user and the First Member.

In a Step B 225 of this analysis, the computed possible gene combinations and their respective statistical likelihoods are correlated with the database of information that indicates known linkages between particular genes and/or particular gene combinations with propensity for certain diseases so as to determine the statistical likelihood that the offspring resulting from the user and the first member would develop and/or have a propensity to develop each one of the certain set of diseases. This statistical likelihood is computed in some embodiments as a “risk factor value” for each one of the certain set of diseases. In one such embodiment the risk factor value is a number from 0 to 100 indicating the risk level for an offspring developing each one of the certain set of diseases. For example, if the analysis computed that the risk factor value for Disease A equal to 0, the offspring would have no chance of developing Disease A. On the other hand if the risk factor value for Disease A was computed to be 100, the offspring would be certain to develop Disease A. Risk factor values between 0 and 100 indicate relative risk levels for an offspring developing diseases A.

Thus at the end of the Step B 225 of the epidemiological analysis, a set of risk factors are computed, each of the risk factors representing the risk level that a child born to the user and the first member would have with respect to developing each of the certain set of diseases. For example, in one embodiment the certain set of diseases include twenty diseases that are known to have significant genetic links. In such an embodiment the set of risk factors represent twenty different risk levels, each of the risk levels indicating the statistical risk that a child born to the user and the first member would have with respect to developing each of the twenty diseases.

Once Step B 225 is completed for the first member, the analysis process described in Step A 220 and Step B 225 repeats for each of the other candidates the set of target candidates until all of the target candidates have been analyzed with respect to the user. This selective repeating function is moderated by conditional relation 230 that directs software flow back to Step A 220 for a next member of the set of target candidates for so long as all of the target candidates have not yet been analyzed with respect to the user. For example, once the first member has been analyzed with respect to the user (as described above) and addition members of the set of target candidates have not yet been analyzed with respect to the user, the process returns to Step A 220 over flow path 235. On this repetition, a second member is now identified for the analysis, genotype data being accessed for the second member. Using the genotype data for the user and the genotype data for the second member, the software routines perform Step A 220, computing the possible gene combinations (and their statistical likelihood) that may result in an offspring born to the user and the second member as the two parents. Next Step B 225 is repeated, now with the new data produced in the repetition of Step A 220. Thus the computed possible gene combinations and their respective statistical likelihoods are correlated with the database of Human Genome Epidemiology Information to determine the statistical likelihood that the offspring resulting from the pairing of the user and the second member would develop and/or have a propensity to develop each one of a certain set of diseases. Again risk factors are computed, this time for the user—second member pairing.

The above steps are repeated until all members of the set of target candidates are analyzed with respect to the user. At the end of this process, a set of risk factors is computed for each pairing of the user with one of the set of target candidates, each set of risk factors indicating the risk level that a child born to that pairing would have with respect to developing each of the certain set of diseases. For example, if there were ten potential candidates identified in the set of target candidates, Step A 220 and Step B 225 would be repeated 10 times (once for each pairing of the user with one of the set of target candidates), thereby producing ten sets of risk factors, each one of the sets of risk factors indicating the risk level that a child born to that pairing would have with respect to developing each of the certain set of diseases.

The final step in the process is the screening step 228 in which only certain of the target candidates are matched with the user based upon the risk levels represented in the sets of risk factors. In one embodiment, only target candidates for which the risk level was computed as 0 for all diseases in the set of certain diseases are identified as potential matches. In other words, only if the pairing of the user with that target candidate would result in offspring that had no chance of developing any of the diseases (or no chance of having a genetically elevated propensity to develop any of the diseases) in the set of certain diseases, would that target candidate be identified as a possible match for the user by the embodiment of the matching service. In other embodiments, only target candidates for which the risk level was computed as below a certain threshold value (for example a risk level of below 1 in 250) for all diseases in the set of certain diseases are identified as potential matches. In other words, only if the pairing of the user with that target candidate would result in offspring that had less than some threshold chance of developing any of the diseases (or less than some threshold chance of having a genetically elevated propensity for any of the diseases) in the set of certain diseases, would that target candidate be identified as a possible match for the user by the embodiment of the matching service.

Once a set of final candidates are identified for the user, the epidemiological analysis operation 204 is complete and the process moves onto the communication operation 206. At this point, the user and each of the identified candidates are given the option of communicating with one another. In some embodiments of the present invention the user and the identified candidates are also informed as to the epidemiological results of their pairing analysis. More specifically, in some embodiments of the present invention the user and each of the final candidates are informed about the statistical likelihood that a child resulting from their specific pairing would develop each of a certain set of diseases and/or would have an elevated propensity to develop each of a certain set of diseases. In this way the user and the target candidates can consider their potential relationship and/or developing relationship with this information in mind. In this way if a user is informed that his pairing with a specific socially compatible candidate would result in no chance of their offspring developing 19 of 20 diseases but a 25% chance of their offspring developing a propensity for a very serious and debilitating diseases, the user can decide based upon this information whether or not he or she wants to initiate a relationship with that candidate. If many other socially compatible candidates are also presented to that user with whom his pairing would result in no chance of their offspring developing 20 of 20 diseases, the user may choose to pursue these other socially compatible candidates first and see what happens. In this way the present invention enables a user to order, prioritize, and/or screen socially compatible candidates based upon an additional epidemiological compatibility analysis.

To enable further customization, a user interface is provided to users of the present invention that enable users to adjust and/or specify and/or otherwise influence the risk threshold levels used in the epidemiological screening process of the present invention. In some embodiments the user can individually adjust and/or specify and/or otherwise influence through the user interface the individual risk threshold levels for specific diseases and/or types of diseases and/or severity of diseases. In this way the user can influence through the user interface of the system the threshold level, for example, of potentially fatal diseases versus substantially non-fatal diseases. In this way the user can specific a very low risk level for potentially fatal diseases and a higher threshold level for substantially non-fatal diseases. This accounts for the fact that different users may have different concerns and preferences with respect to the acceptable risk levels associated with different diseases and/or types of diseases and/or severity of diseases.

To enable further customization, a user interface is provided to users of the present invention that enable users to adjust and/or specify and/or otherwise influence the relative importance of social factors versus geno-epidemiological factors in the screening process that produces the set of final candidates. This accounts for the fact that different users may have different preferences as to the relative importance of a highly compatible social match versus a highly compatible epidemiological match.

Finally, the present invention may be configured with default values that set the relative importance (i.e., weighting) of different diseases and/or types of diseases and/or severity of diseases when performing the matching of candidates and producing the set of final candidates. Similarly, the present invention may be configured with default values that set the relative importance (i.e., weighting) of social factors versus geno-epidemiological factors in the screening process that produces the set of final candidates. In some such embodiments, the default values may be modified by users using the user interface functionality of the present invention.

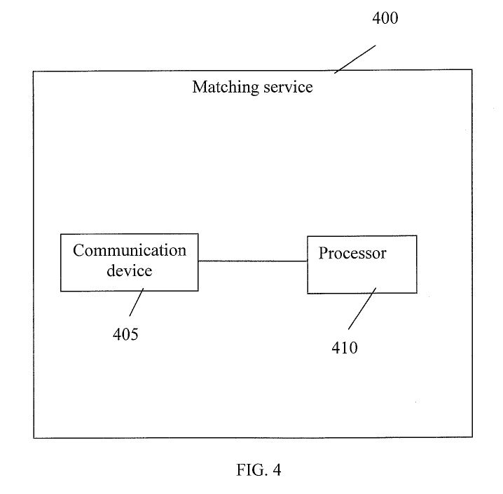

FIG. 4 illustrates a matching service 400 according to at least on embodiment of the invention. A communication device 405 receives a match request from a user of a remote unit and accesses a server storing epidemiological factors for a set of candidates. A processor 410 matches the user with a target set of candidates based on social factors and to match the user with at least one final candidate from the set of target candidates based on the epidemiological factors, and to facilitate communication between the remote unit and the at least one final candidate via a network.

Other embodiments, combinations and modifications of this invention will occur readily to those of ordinary skill in the art in view of these teachings. Therefore, this invention is not to be limited to the specific embodiments described or the specific figures provided.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art account automatically credited for the exposure to those advertisements.

While the invention herein disclosed has been described by means of specific embodiments and applications thereof, numerous modifications and variations could be made thereto by those skilled in the art without departing from the scope of the invention set forth in the claims.

What is claimed is:

1. A method for computer moderated man-woman matchmaking comprising:
matching a user with a set of target candidate persons based at least in part on a social compatibility determination with respect to the set of target candidates persons;
matching the user with at least one final candidate person from the set of target candidate persons based at least in part upon an epidemiological compatibility determination with respect to the set of target candidate persons; and
facilitating communication between the user and the at least one final candidate person through at least one communication medium.

2. The method of claim 1, wherein the matching of the user with the at least one final candidate comprises assessing a statistical risk of the user having offspring with propensity for at least one predetermined disease when matched with each of a plurality of target candidate persons.

3. The method of claim 2, wherein the user is presented with at least one representation of the statistical risk associated with the at least one final candidate.

4. The method of claim 2, wherein the matching of the user with at least one final candidate further comprises selecting the at least one final candidate from the plurality of target candidate persons based at least in part upon the statistical risk associated with at least one disease being lower with respect to the at least one final candidate than with respect to other of the plurality of target candidates.

5. The method of claim 2, wherein the assessing comprises referencing genetic information for the user as well as for each of the plurality of target candidates.

6. The method of claim 5, wherein the assessing further comprises referencing Human Genome Epidemiological information.

7. The method of claim 6, wherein the Human Genome Epidemiological information comprises known relations between at least one of particular genes and gene combinations with a propensity for certain diseases.

8. The method of claim 7, wherein the certain diseases comprise at least one of: Breast Cancer, Prostate Cancer, Alzheimer Disease, Coronary Artery Disease, Obesity, Colon Cancer, Lung Cancer, Diabetes, Skin Cancer, Schizophrenia, Alcoholism, Atherosclerosis, and Osteoarthritis.

9. The method of claim 1, wherein the social compatibility determination comprises an assessment of at least one personality characteristic of the user and at least one personality characteristic of each of a plurality of target candidates.

10. The method of claim 1, wherein the matching the user with at least one final candidate person is based at least in part upon the epidemiological compatibility determination yielding at least one risk level for disease being below at least one threshold level set by the user.

11. A system for computer moderated man-woman matchmaking comprising:
a matching service to match a user with a set of target candidate persons based at least in part on a social compatibility determination with respect to the set of target candidate persons and to match the user with at least one final candidate person from the set of target candidate persons based at least in part upon an epidemiological compatibility determination with respect to the target candidate persons; and
a remote unit corresponding to the user to communicate with the matching service and the at least one final candidate via a network.

12. The system of claim 11, wherein the matching of the user with at least one final candidate comprises assessing a statistical risk of the user having offspring with propensity for at least one predetermined disease when matched with each of a plurality of target candidates.

13. The method of claim 12, wherein the user is presented with at least one representation of the statistical risk associated with the at least one final candidate.

14. The system of claim 12, wherein the assessing comprises referencing genetic information for the user and for each of the plurality of target candidates.

15. The system of claim 14, wherein the assessing further comprises referencing Human Genome Epidemiological information from a database.

16. The system of claim 15, wherein the Human Genome Epidemiological information comprises known relations between at least one of particular genes and gene combinations with a propensity for the at least one predetermined disease.

17. The method of claim 11, wherein the social compatibility determination comprises an assessment of at least one personality characteristic of the user and at least one personality characteristic of each of a plurality of target candidates.

18. The method of claim 11, wherein the selection of the at least one final candidate is based at least in part upon the epidemiological compatibility determination yielding at least one risk level for disease being below at least one threshold level set by the user.

19. A method for computer moderated man-woman matchmaking comprising:
matching a user with at least one prospective mate based at least in part upon both a social compatibility determination and an epidemiological compatibility determination of the user with respect a plurality of candidate mates; and
facilitating communication between the user and the at least one prospective mate through at least one communication medium.

20. The method of claim 19, wherein the matching of the user with at least one prospective mate comprises assessing a statistical risk of the user having offspring with a propensity for at least one predetermined disease when matched with each of a plurality of candidate mates.

21. The method of claim 20, wherein the matching of the user with the at least one prospective mate further comprises selecting the at least one prospective mate from the plurality of candidate mates based at least in part upon the statistical risk associated with the at least one predetermined disease being lower with respect to the at least one prospective mate than with respect to other of the plurality of candidate mates.
